(19) United States
(12) Patent Application Publication
(10) Pub. No.: US 2008/0270888 A1
(43) Pub. Date: Oct. 30, 2008

(54) Method For Generating Metadata For Symbolic Music of Traditional Music, and Apparatus For Coding/Decoding Multimedia Data Using the Same

(75) Inventors: Yong-Ju Cho, Seoul (KR); Jae-Gon Kim, Daejeon (KR); Jin-Woo Hong, Daejeon (KR); Hyoung-Joong Kim, Seoul (KR); Yong-Soo Choi, Gangwon-do (KR)

Correspondence Address: LADAS & PARRY LLP, 224 SOUTH MICHIGAN AVENUE, SUITE 1600, CHICAGO, IL, 60604, US

(73) Assignees: ELECTRONICS AND TELECOMMUNICATIONS RESEARCH INSTITUTE, DAEJON (KR); KNU-Industry Cooperation Foundation, Gangwon-do (KR)

(21) Appl. No.: 11/815,579

(22) PCT Filed: Jul. 12, 2005
(86) PCT No.: PCT/KR05/02242

§ 371 Date: Aug. 6, 2007

(30) Foreign Application Priority Data
Feb. 7, 2005 (KR) 10-2005-0011379

(51) Int. Cl. G06F 17/21

(52) U.S. Cl. 715/234

(57) ABSTRACT

Provided is a method for generating metadata for symbolic music and a music restoring apparatus employing the same, and more particularly, a method for generating metadata for ornaments existing in the Korean traditional music and an apparatus for restoring multimedia including the same. A method for generating metadata for music, which is suggested in the present invention, includes the steps of: a) generating an extensible Markup Language (XML) notation for ornaments; b) generating a complete form of metadata including the XML notation; and c) generating metadata for entire music by using the complete form of metadata and the XML notation.

### TECHNICAL FIELD

The present invention relates to a method for generating metadata for symbolic music and an apparatus for restoring multimedia data employing the same; and, more particularly, to a method for generating metadata for ornaments existing in Korean traditional music and a method for coding/decoding multimedia data including the metadata.

### BACKGROUND ART

Korean traditional music, which is called Kukakh, is composed of melodies without chords. Each sound of melody uses an ornament to thereby have a meaning in musical context. In other words, a sound may be vibrated and another sound may be pulled down, and yet another sound may be played flat without any variation. This is to make each sound function uniquely in an organization of notes that form a piece of music.

The sound variation includes yoseong and nonghyun, both of which mean vibrating sounds. Yoseong is a term usually used in vocal music or pipe music, whereas nonghyun is a term usually used in string music, such as kayakum and keomungo, which are Korean traditional string instruments. The two terms basically means the same. Strictly, nonghyun not only means a vibrating sound but also it includes teoiseong, which means a descending sound pulled down, a chuseong, which means an ascending sound pulled up, and a pyeongseong, which means a flat sound without vibration.

However, not all kukakh music vibrates sounds. Sounds vibrated in the way of nonghyun or yoseong are different according to each musical piece or the tune of each musical piece, and the width of sound variation is different. Royal music or noble music which is expressed with suppressed emotion includes narrow nonghyun, whereas popular music such as minyo, pansori and sanjo includes many wide nonghyun expressions and has various types of nonghyun.

In the Western music, there is an expression called ‘vibrato.’ Since vibrato of the Western music is different from nonghyun of the Korean traditional music, the exquisiteness of nonghyun cannot be expressed by the notation of vibrato.

Recently, diverse electric notations such as Wedelmusic and Musicxml are developed to notate music in the Western music. Nonghyun of the Korean traditional music, too, needs to be notated as digital data. Also, it is very important to include nonghyun notation into the notation of the Western music to clearly express the characteristics of the Korean music.

According to a Call for Proposal for Symbolic Music Representation, which will be used in the same meaning as metadata representation, hereinafter, in the ISO/IEC JTC1/SC29/WG11 N6689, a methodology for representing metadata of the Korean traditional music is required to integrate the Korean traditional music with the Moving Picture Experts Group (MPEG) music notation.

Since the 15^{th} century, the Korean traditional music, which is known as Kukakh, has used jeongganbo, which is a Korean traditional music notation method. The Western notation method and jeongganbo are still used in Korea. Although and jeongganbo is very different from the Western notation, it can be represented in a markup language which is used to notate the Western music because music is music after all.

However, some typical ornaments of jeongganbo do not exist in the Western music at all. Therefore, when the typical characteristics of the Korean traditional music are standardized, existing music metadata can be extended and the typical characteristics of the Korean traditional music can be represented according to the standard symbolic music representation.

### DISCLOSURE

### Technical Problem

It is, therefore, an object of the present invention to provide a method for generating metadata for ornaments existing uniquely in the Korean traditional music.

It is another object of the present invention to provide an apparatus for generating multimedia data including unique ornaments of the Korean traditional music to thereby apply them to the Western music and an apparatus for coding/decoding multimedia data including metadata for the ornaments of the Korean traditional music.

### Technical Solution

The other objects and advantages of the present invention will be understood by the following description, and the preferred embodiments. Also, it is obvious to those skilled in the art of the present invention that the objects and advantages of the present invention can be realized by the means as claimed and combinations thereof.

### Advantageous Effects

The technology of the present invention provides a method for generating metadata for ornament uniquely existing in the Korean traditional music, and thus makes it possible to represent ornaments of the Korean traditional music according to standard symbolic music representation and extend music representation.

### DESCRIPTION OF DRAWINGS

The above and other objects and features of the present invention will become apparent from the following description of the preferred embodiments given in conjunction with the accompanying drawings, in which:

FIG. 1 illustrates an example of a double system of a Korean traditional music notation;

FIG. 2 shows an example of a triple system of the Korean traditional music notation;

FIG. 3 is a flowchart describing a method for generating metadata for ornaments in accordance with an embodiment of the present invention;

FIG. 4 shows a complete form of metadata including an eXtensible Markup Language (XML) notation corresponding to ornaments in accordance with an embodiment of the present invention;

FIG. 5 shows a structure of metadata for ornaments in accordance with another embodiment of the present invention;

FIG. 6 shows a schema structure of nonghyun among elements of the ornaments disclosed in FIG. 5;

FIG. 7 shows a schema structure of sliding among the elements of the ornaments disclosed in FIG. 5; and

FIGS. 8 and 9 are block diagrams showing an apparatus for coding multimedia data and an apparatus for decoding the multimedia data in accordance with embodiments of the present invention.

### BEST MODE FOR THE INVENTION

Other objects and aspects of the invention will become apparent from the following description of the embodiments with reference to the accompanying drawings, which is set forth hereinafter. When it is considered that detailed description of a related art may obscure the points of the present invention, the description will not be provided therein. Hereinafter, preferred embodiments of the present invention will be described with reference to the accompanying drawings.

Just as a musical score expresses music in the Western music, jeongganbo expresses music in the Korean traditional music. Jeongganbo that can express pitches and rhythms in a simple manner is an organized and regular form of music notation which is invented for the first time in the East Asia. ‘Jeonggan’ of jeongganbo means rectangular grids and ‘bo’ means a musical score. Jeongganbo basically uses 12 Chinese characters to notate 12 pitches within an octave. One pitch is notated by one Chinese character in one rectangular grid. A blank grid means the previous notation is maintained. One grid stands for one beat. The number of grids signifies the number of beats. For example, when one grid including one Chinese character is followed by one blank grid, it means two beats. The number of small rectangles in one rectangular grid, which is called jeonggan, denotes the number of notes for one beat.

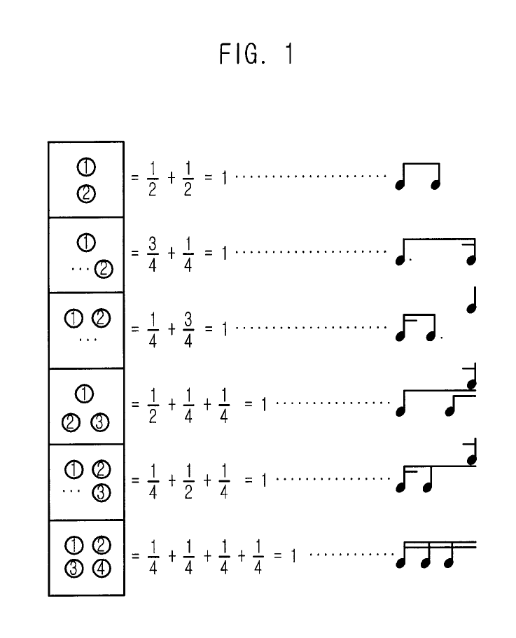

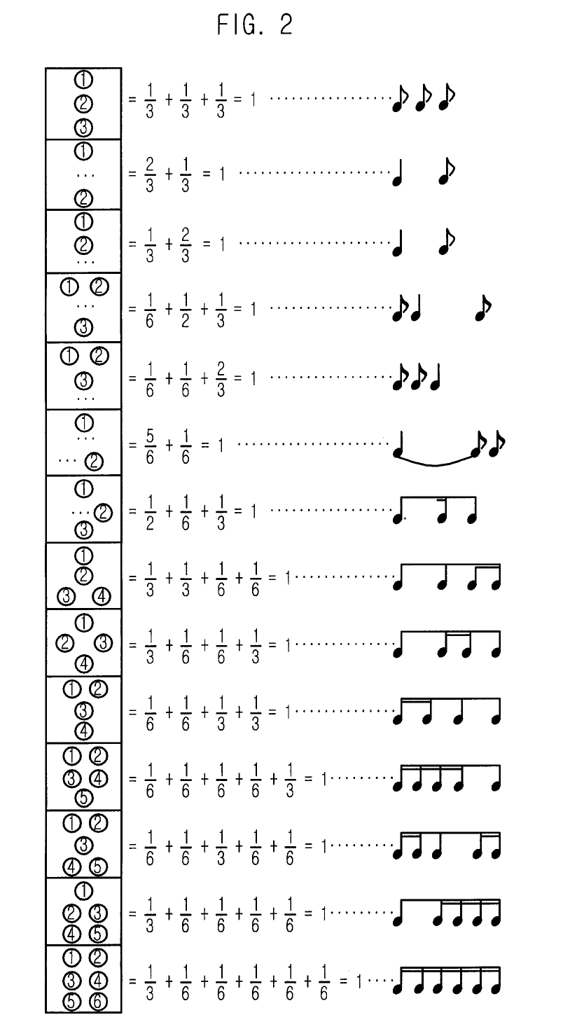

FIG. 1 illustrates an example of a double system of a Korean traditional music notation, and FIG. 2 shows an example of a triple system of a Korean traditional music notation.

An additional sign for an ornament is provided next to the notes in a musical score. However, some ornaments used in the Korean traditional music cannot be expressed by a Western music notation. The ornaments written in the jeongganbo are unique to the Korean traditional music and they are for only the Korean traditional music instruments. Hereinafter, the unique ornaments existing only in the Korean traditional music will be referred to as just ‘ornaments,’ too.

The following Table 1 shows signs for the unique ornaments existing in the Korean traditional music notated in jeongganbo.

TABLE 1

| | | | | | | | |
|---|---|---|---|---|---|---|---|
| [symbol] | [symbol] | [symbol] | [symbol] | [symbol] | [symbol] | [symbol] | [symbol] |

The ornament signs shown in Table 1 denote a tone ascending to a high sound, a tone ascending to high sounds twice, a tone descending to a low sound, a tone falling down to a low sound and then ascending back to a high sound, and nonghyun including narrow vibration, wide vibration, ascending vibration and descending vibration.

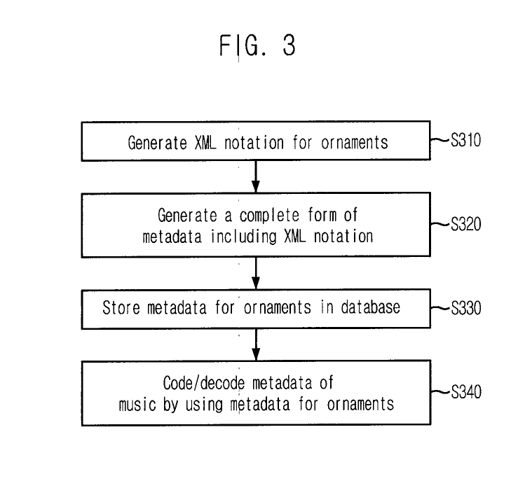

FIG. 3 is a flowchart describing a method for generating metadata for ornaments in accordance with an embodiment of the present invention.

First, in step S310, XML notation for the ornaments shown in Table 1 is generated. Herein, the structure of the XML notation corresponding to each ornament is as shown in the following Table 2.

TABLE 2

| Mark | Explanation | XML Notation |
|---|---|---|
| [symbol] | Sliding tone to higher | <sliding> up </sliding> |
| | (can visually show how | |
| | long and deep) | |
| [symbol] | Sliding tone to lower | <sliding> down </sliding> |
| | (can visually show how | |
| | long and deep) | |
| [symbol] | Two times Sliding tone | <sliding> double-up </sliding> |
| | to higher | |
| [symbol] | Sliding tone to lower | <sliding> down-up </sliding> |
| | and higher | |
| [symbol] | Nonghyun(Vibrato) | <nonghyun> increase </nonghyun> |
| [symbol] | (can visually show | <nonghyun> decrease </nonghyun> |
| [symbol] | increase, decrease, | <nonghyun> narrow </nonghyun> |
| [symbol] | narrow or wide) | <nonghyun> wide </nonghyun> |

In step S320, a complete form of metadata including the XML notation generated in the step S310 is generated. Inserting an XML notation for the ornaments shown in the Table 2 can enrich the current music notation methods. For example, the notation of jeongganbo in FIG. 3 can be represented as XML, which is shown below:

<pitch>

<step>F</step>
<sliding>up</sliding>
<octave>4</octave>
</pitch>
<duration>2</duration>

The XML data of the jeongganbo include pitch information, ornament information and octave information. Therefore, jeongganbo can be represented by the Western music notation based on the ornaments of the Table 2 and the XML notation corresponding to the ornaments. Also, it is possible to graft the unique ornaments of the Korean traditional music into the Western musical scale. For example, when the XML notation for the ornaments is added to the metadata for a Western musical scale ‘do,’ it is possible to express the Western musical scale ‘do’ in a tone ascending high or in a nonghyun tone.

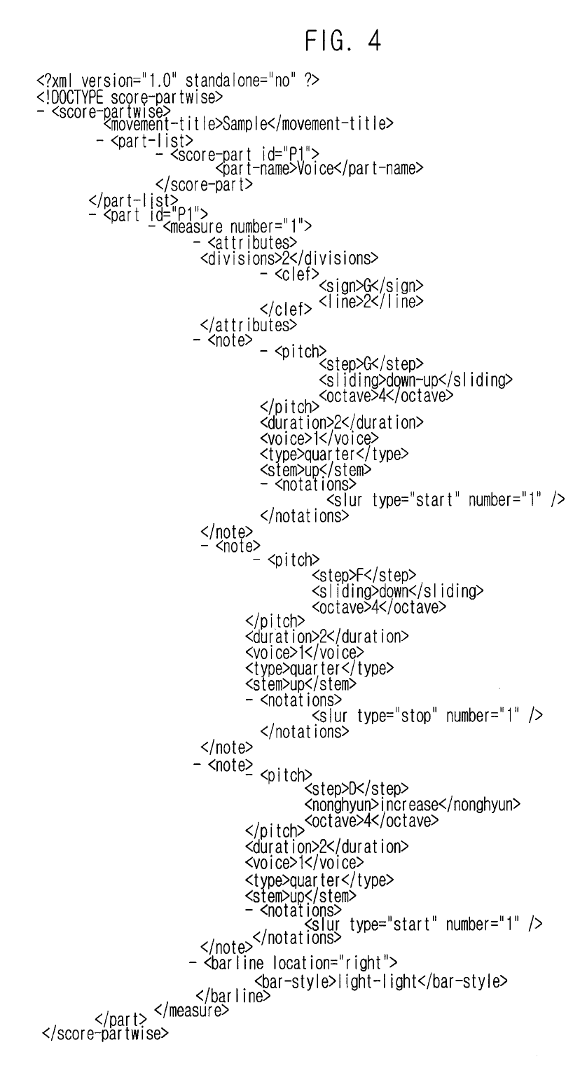

FIG. 4 shows a complete form of metadata including an XML notation corresponding to the ornaments.

FIG. 4 shows an example of a complete form of metadata including sliding and nonghyun, which are presented in the Table 2.

In step S330 after the step S320, a database is built up by using the metadata for the ornaments, which are generated in the steps S310 and S320. Subsequently, in step S340, music is restored and recorded by using the metadata for ornaments which are stored in the database formed in the step S330 during coding/decoding of the music.

To describe the process in the step S340 in detail, when it is determined before the restoration of music that there are metadata for ornaments in the database among metadata for the entire music, sounds corresponding to the metadata are restored with the ornaments expressed. When the music is coded, notes with the ornaments form sounds by referring to the metadata for ornaments which are stored in the database.

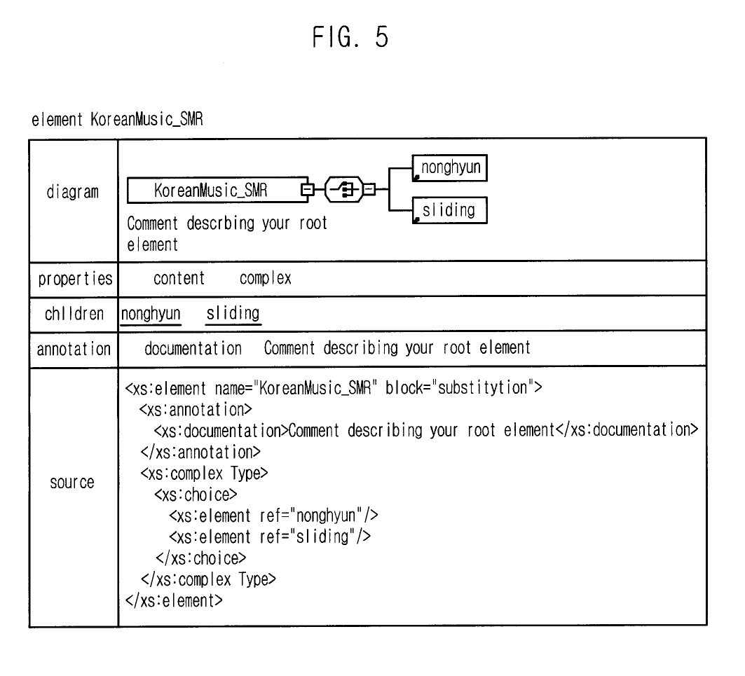

FIG. 5 shows a complete form of metadata for ornaments including sliding and nonghyun which are presented in the Table 2 in accordance with another embodiment of the present invention.

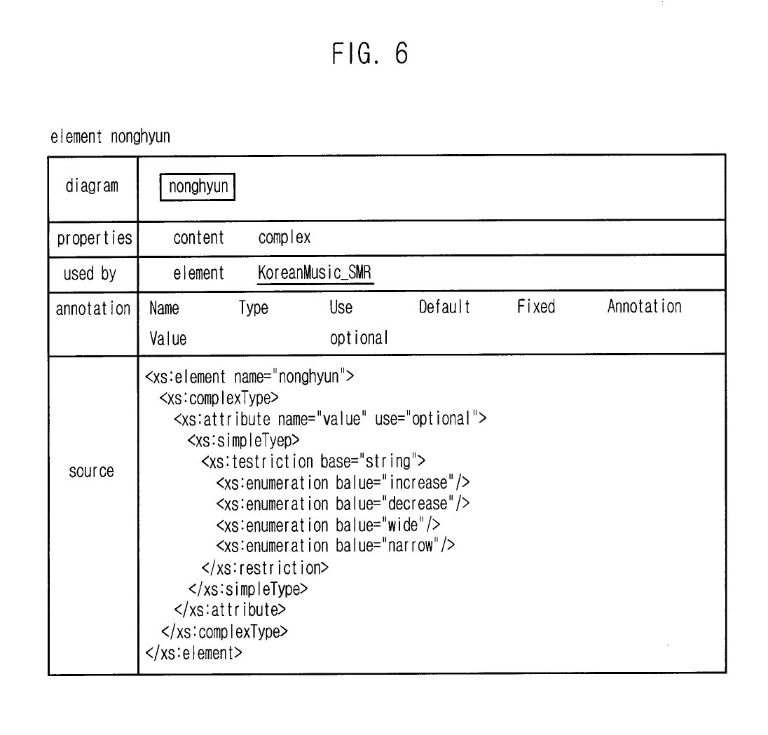

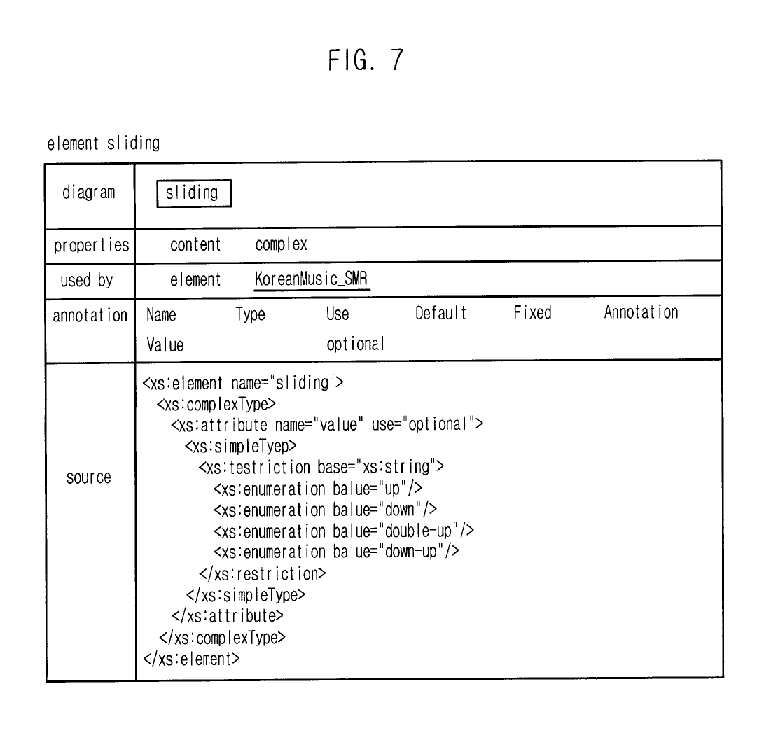

Referring to FIG. 5, a method for generating metadata for ornaments, which are suggested in another embodiment of the present invention, includes the steps of: a) generating an XML schema structure for ornaments existing in the Korean traditional music; b) generating a schema for nonghyun, which is an element of the ornaments; and c) generating a schema for sliding, which is also an element of the ornaments. Herein, the schemas for the nonghyun and sliding are as shown in FIGS. 6 and 7.

FIG. 6 shows a schema of nonghyun among elements of the ornaments disclosed in FIG. 5.

FIG. 7 shows a schema of sliding among the elements of the ornaments disclosed in FIG. 5.

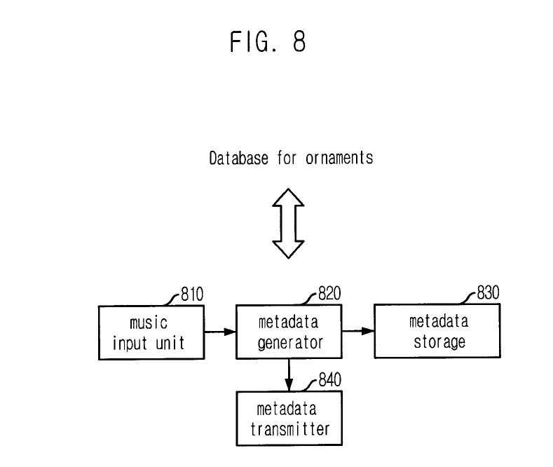

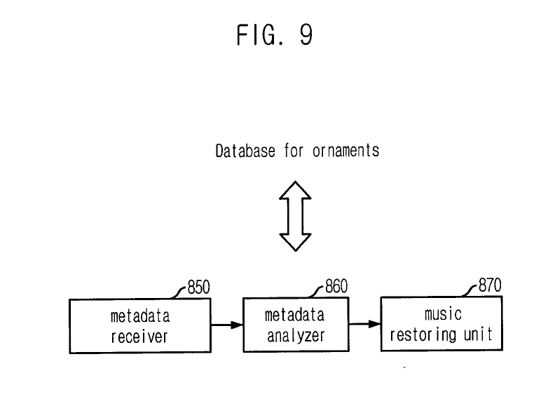

FIGS. 8 and 9 are block diagrams showing an apparatus for coding multimedia data and an apparatus for decoding the multimedia data in accordance with embodiments of the present invention.

Referring to FIG. 8, the multimedia data coding apparatus includes a music input unit 810, a metadata generator 820, a metadata storage 830, and a metadata transmitter 840. The music input unit 810 receives speech and music through a common microphone. The metadata generator 820 generates metadata for music inputted through the music input unit 810. Herein, the metadata for music data follow the MPEG Standards. The metadata generator 820 generates metadata by referring to a database (not shown) including metadata for ornaments, when music includes ornaments. Music metadata generated in the metadata generator 820 are stored in the metadata storage 830 or transmitted outside through the metadata transmitter 840.

Referring to FIG. 9, the multimedia data decoding apparatus includes a metadata receiver 850, a metadata analyzer 860, and a music restoring unit 870.

The metadata receiver 850 receives music metadata inputted through a network and/or metadata stored in a predetermined memory (not shown). The metadata analyzer 860 extracts metadata for music from the metadata received through the metadata receiver 850. Also, it checks whether there are metadata for ornaments in the extracted metadata for music. If there are metadata for ornaments in the metadata receiver 850, the music restoring unit 870 restores the music by referring to the metadata for ornaments in the database (not shown).

The above-described method of the present invention can be realized as a program and stored in a computer-readable program, such as CD-ROM, RAM, ROM, floppy disks, hard disks, and magneto-optical disk. Since this process can be easily implemented by those skilled in the art of the present invention, detailed description on it will not be provided herein.

While the present invention has been described with respect to certain preferred embodiments, it will be apparent to those skilled in the art that various changes and modifications may be made without departing from the scope of the invention as defined in the following claims.

What is claimed is:

1. A method for generating metadata for music, comprising the steps of:
a) generating an eXtensible Markup Language (XML) notation for ornaments;
b) generating a complete form of metadata including the XML notation; and
c) generating metadata for entire music by using the
XML notation and the complete form of metadata.

2. The method as recited in claim 1, wherein the XML notation for ornaments is as shown in the following table:

| Mark | Explanation | XML Notation |
|---|---|---|
| [symbol] | Sliding tone to higher | <sliding> up </sliding> |
| | (can visually show how | |
| | long and deep) | |
| [symbol] | Sliding tone to lower | <sliding> down </sliding> |
| | (can visually show how | |
| | long and deep) | |
| [symbol] | Two times Sliding tone | <sliding> double-up </sliding> |
| | to higher | |
| [symbol] | Sliding tone to lower | <sliding> down-up </sliding> |
| | and higher | |
| [symbol] | Nonghyun(Vibrato) | <nonghyun> increase </nonghyun> |
| [symbol] | (can visually show | <nonghyun> decrease </nonghyun> |
| [symbol] | increase, decrease, | <nonghyun> narrow </nonghyun> |
| [symbol] | narrow or wide) | <nonghyun> wide </nonghyun> |

3. The method as recited in claim 1, wherein the complete form of metadata includes at least one selected from the group consisting of pitch information, ornament information, and octave information.

4. A method for generating metadata for symbolic music, comprising the steps of:
a) generating an XML schema for ornaments existing in Korean traditional music;
b) generating a schema for nonghyun which is an element of the ornaments; and
c) generating a schema for sliding which is an element of the ornaments.

5. The method as recited in claim 4, wherein the schema of nonghyun is represented as:
<xs:element name=“nonghyun”>
<xs:complexType>
<xs:attribute name=“value” use=“optional”>
<xs:simpleType>
<xs:restriction base=“xs:string”>
<xs:enumeration value=“increase”/>
<xs:enumeration value=“decrease”/>
<xs:enumeration value=“wide”/>
<xs:enumeration value=“narrow”/>
</xs:restriction>
</xs:simpleType>
</xs:attribute>
</xs:complexType>
</xs:element>

6. The method as recited in claim 4, wherein the schema of sliding is represented as:
<xs:element name=“sliding”>
<xs:complexType>
<xs:attribute name=“value” use=“optional”>
<xs:simpleType>
<xs:restriction base=“xs:string”>
<xs:enumeration value=“up”/>
<xs:enumeration value=“down”/>
<xs:enumeration value=“double-up”/>
<xs:enumeration value=“down-up”/>
</xs:restriction>
</xs:simpleType>
</xs:attribute>
</xs:complexType>
</xs:element>

7. An apparatus for coding multimedia data, comprising:
a music input unit for receiving music;
a metadata generator for generating metadata for music inputted through the music input unit, and when there is an ornament in the music, generating metadata for the music by referring to metadata for ornaments stored in a database; and
a metadata output unit for outputting the music metadata generated in the metadata generator.

8. The apparatus as recited in claim 7, wherein the music metadata provide schemas for sliding and nonghyun.

9. An apparatus for decoding multimedia data, comprising:
a metadata receiver for receiving metadata;
a metadata analyzer for extracting metadata for music from the metadata received in the metadata receiver and checking whether there are metadata for ornaments in the extracted music metadata; and
a music restoring unit for restoring music by referring to metadata for ornaments stored in a database, when there are metadata for ornaments in the extracted music metadata.

10. The apparatus as recited in claim 9, wherein the music metadata provide schemas for sliding and nonghyun.

11. A structure of metadata for music, comprising:
a schema corresponding to nonghyun;
a schema corresponding to sliding; and
a schema corresponding to ornaments using the sliding and nonghyun.
